(19) United States
(12) Patent Application Publication
(10) Pub. No.: US 2004/0131333 A1
(43) Pub. Date: Jul. 8, 2004

(54) Playback device for audio and/or video content

(76) Inventors: Kam Keung Fung, Hong Kong (HK); Yau Wing Tsang, Hong Kong (HK); Rocky O. Caldwell, Carmel, IN (US); Tibor George Csicsatka, San Diego, CA (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/337,697

(22) Filed: Jan. 6, 2003

(51) Int. Cl. H04N 5/783

(52) U.S. Cl. 386/69; 386/70

(57) ABSTRACT

The invention refers to a playback device for audio and/or video content which content (C) is stored on a content memory (1), the device having

a content reader (2) for reading content (C) from said content memory (1)

an output (3) for outputting content (C) provided by said content reader (2)

an index memory (6) for storing index data related to content (C) stored on said content memory (1)

a user interface (5) for receiving user input

a random succession generator (7) for randomly selecting a random succession (RS) of content to be played back and

a playback controller (4) for controlling playback of content (C) in response to said random-succession (RS).

According to the invention the device is provided with a weighting generator (11) for generating a weighting factor (WF) for at least a part of said content (C), based on user input and in that the random succession generator (7) takes into account said weighting factors (WF).

### FIELD OF THE INVENTION

The invention refers to a playback device for audio and/or video content and a method for automatically generating a succession of content to be played by such device.

### BACKGROUND OF THE INVENTION

The invention is based on a playback device for audio and video content which content is stored on a content memory. Audio content may be uncompressed music as e.g. known from compact discs or compressed audio data as for example MP3. Video content may for example be MPEG compressed video streams or any other compressed or uncompressed video content. Such audio or video content or both may be stored on a content memory as an optical disc, a magnetic disc or tape or any other exchangeable medium as for example electronic memory like flash ROM card. The content memory may as well be fixed inside the device as an RAM or ROM unit. Also a combination of exchangeable and non-exchangeable content memory may be implemented. The device is provided with a content reader as an optical pick up or an access device to electronic memory, for reading content from said content memory. The device is further provided with an output for outputting content received from the content reader. Such output may be a loudspeaker, a graphic or video display etc. as appropriate for the content stored. It may also be a connector to such loudspeaker, earphone etc. if such output means is not integrated in the device itself. An index memory is provided for storing index data related to content stored on said content memory making it possible to quickly access and/or to update content on the content memory, especially in case of exchangeable content memory or in case of recording additional items to the content memory or removing other items from the content memory. The device is further provided with a user interface as commonly known, as well as with a random succession generator for randomly selecting a random succession of content to be played back (as is for example known under the name of shuffle playback). The device is further provided with a playback controller for controlling playback of content as well as, at least partly, for performing general control functions as control of normal play, random or shuffle play etc. It is an object of the invention to improve such device.

### SUMMARY OF THE INVENTION

According to the invention the device is provided with a weighting generator for generating a weighting factor for at least a part of said content based on user input where in the random succession generator takes into account said weighting factors. The weighting factor is according to a first variant of the invention, stored in a weighting factor memory. According to a second variant of the invention, the weighting factor is used to add the related item to a certain play list, being connected to that weighting factor and/or to remove the item from a certain respective play list. The random succession generator takes into account said weighting factors either directly from a weighting factor memory or indirectly from accordingly generated play lists. Advantage of this improvement is that a more user-friendly behaviour of the device is reached. Playback in a random succession mode is made with a higher likelihood for those items the user has indicated as liked by him, and with a lower likelihood for those items the user has indicated a dislike, while a medium likelihood is chosen for those items neither indicated to be liked or disliked. Of course, this is only one example for advantageously making use of the inventive idea.

The user interface of a device according to the invention is advantageously provided with first input for increasing a weighting factor and a second input for decreasing a weighting factor. These inputs are for example buttons to indicate whether the user prefers or not prefers the item currently played back. In response to this input a change of the weighting factor is performed. This has the advantage that it is an easy and user-friendly input means.

According to another improvement of the invention the user interface is provided with a user behaviour evaluator for evaluating, from the user input behaviour, a criterion for increasing or decreasing a weighting factor. The user input behaviour evaluated is for example a loudness change for a certain item, a single skip or a single repeat command for a certain item or a single jump to a certain item of content etc. Advantage is, that such user behaviour evaluator allows for automatically generating a selection of items liked or disliked by the user without the users need to specifically indicate his desires.

A device according to the invention is advantageously provided with a play list generator for generating a play list based on weighting factor. The play list generator generates for example a “like” play list for all content having weighting factor greater than one, and generates a “dislike” play list for all content having weighting factors smaller than one and/or generates play lists for certain ranges of weighting factors. Here too, the weighting factor needs not necessarily be used, another preferred variant is that, based on user input options, different play lists are generated, wherein each play list corresponds to a certain weighting factor. For example a play list is generated for items the user indicates as “liked” items, another play list for items the user indicates as “disliked” items etc

A method for automatically generating a succession of content to be played back from a content memory according to the invention has the steps as indicated in the independent method claim. This has the advantage that content stored on the play list is replayed with higher probability than the other content, such making a device working according to this method more user-friendly.

Advantageously the user input is selected from at least two different options, said options causing different weighting factor assignment. The options are advantageously a “like” and a “dislike” option, but also options as “like much”, “dislike much”, “use never”, “use very often” etc. are also advantageously implemented. The different weighting factors are accordingly for example ×2 or ×0.5 for simple like/dislike option and higher factors as ×4 or “set four times higher than any other factor” for a “like much” or “use very often” option and respectively lower factors as ×0.25 or “set to zero” for “dislike much” or “use never” option. Of course, here too, the weighting factor assignment may consist in assigning the items to a certain play list. The advantage of this feature is easy handling for the user as well as easy processing for the device.

The step of assigning a weighting factor advantageously comprises taking a predefined weighting factor value or replacing an existing weighting factor by said predefined weighting factor and changing an existing weighting factor. The replacement option has the advantage that it is an easy solution, which is easy to implement. The changing solution is also easy to implement and increases the possibilities for different treatment.

Advantageously at least two different play lists are generated in response to different user input options. Another advantages solution is to evaluate user input to derive a criterion for assigning an item of content to a certain play list.

Advantageously, several play lists are combined in a single table each item of the table having a weighting factor assigned thereto. Said weighting factor is advantageously used as one criterion to define the items belonging to a certain play list. This has the advantage to be a simple solution to combine a large number of play lists or weighting factor steps in a single table.

Advantageously, the automatically generated succession is edited by transferring it to an editing device, amending it there, and transferring it back. The editing device is conveniently a separate device like a personal computer. It may, however, also advantageously be incorporated in the device used for generating the succession. Editing includes but is not limited to review, change, delete from or add to the selection, as well as re-compressing the items of the selection.

It is to be noted that implementations of the inventive idea not directly mentioned here as well as advantageous combinations of the described features also lie within the scope the invention. Further advantages will become apparent from the following description of preferred embodiments, wherein:

### BRIEF DESCRIPTION OF THE DRAWINGS

FIG. 1 shows a block diagram of a device according to the invention,

FIG. 2 shows a schematic view of a device according to the invention,

FIG. 3 shows a flow chart of a method according to the invention,

FIG. 4 shows an alternative version of a part of FIG. 3,

FIG. 5 shows another alternative version of a part of FIG. 3,

FIG. 6 shows another alternative version of a part of FIG. 3,

FIGS. 7a, 7b show examples of an index memory,

FIGS. 8a, 8b show examples of a play list memory.

### DETAILED DESCRIPTION OF PREFERRED EMBODIMENTS

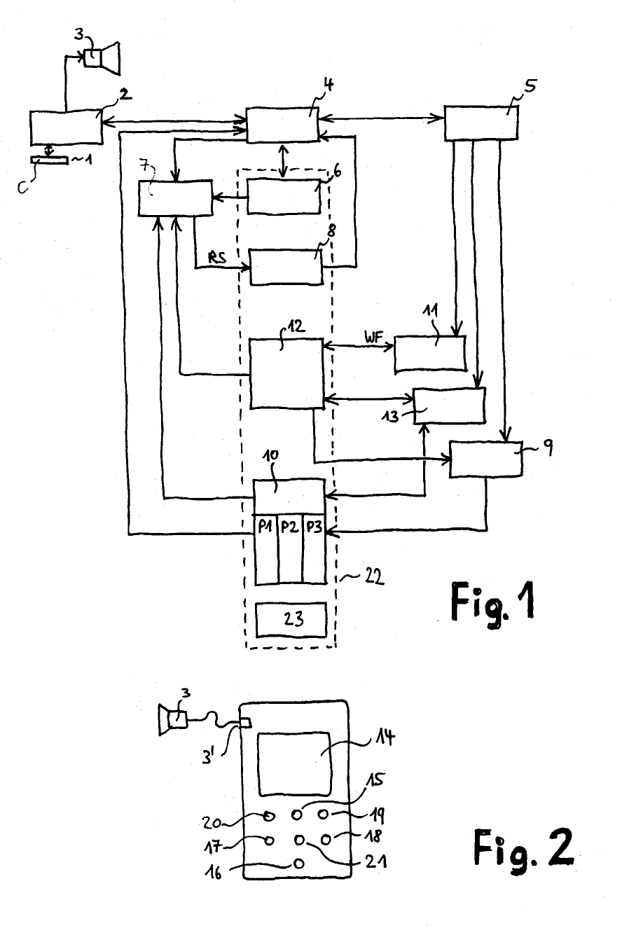

FIG. 1 shows a block diagram of a device according to the invention, wherein those parts, which are not necessary for describing the invention are omitted. A content memory 1 is accessed by a content reader 2 for reading items of content C from the content memory 1 or for writing items of content C to the content memory 1. Items of content C read by the content reader 2 are provided to an output 3, which is in this example indicated as a loudspeaker. The content reader 2 is controlled by a playback controller 4 which itself cooperates with a user interface 5 to receive instructions from a user of the device and for providing information to said user. The playback controller 4 also cooperates with an index memory 6 wherein index information related to items of content stored on the content memory 1 are provided, as for example title of an item, address of said item on the content memory 1, etc. In case of an exchangeable content memory 1 or in case of adding/removing items to/from said content memory 1, the playback controller 4 updates the index memory 6 accordingly. In case of a play command issued by the user interface 5 the playback controller 4 instructs the content reader 2 to read and output items of content C from the content memory 1 according to a given succession, for example according to a rising index number in the index memory 6. In case of so-called shuffle mode, the playback controller 4 instructs a random succession generator 7 to generate a random succession of items of content, using data stored in the index memory 6. The random succession generated by the generator 7 is stored in a random succession memory 8. For performing shuffle play back the playback controller 4 instructs the content reader 2 to read and output the succession as stored in memory 8.

The user interface 5 is also used to generate a play list P1 defined by the user. In this case the playback controller 4 provides the user interface 5 with all or selected items from the index memory 6 so that the user can select, using user interface 5, several of those items. A play list generator 9 accumulates indices of the respective items of content and stores them as play list P1 in a play list memory 10. If playback of the play list is required via user interface 5, playback controller 4 takes the succession of the indices stored in play list P1 to instruct content reader 2 to read the respective items of content from content memory 1 and to output them. Here, too, shuffle mode is possible. In this case playback controller 4 instructs random succession generator 7 to take indices from play list P1 to generate a random succession to be stored in random succession memory 8.

The user interface 5 according to the invention is provided with input means to input a user's vote with regard to the item of content currently played back. According to a preferred embodiment two voting possibilities exist to indicate user's like or dislike with regard to the current item of content. A weighting generator 11 generates, upon receipt of such vote, a weighting factor related to the item of content currently played back and stores it in a weighting factor memory 12. For random play back or shuffle play back or so-called smart shuffle play back, the random succession generator 7 takes into account data of index memory 6 as well as the weighting factors of weighting factor memory 12 for generating a random succession. Items of data for which the user gives the vote “like” will have a higher likelihood to occur in the random succession than items without any vote which themselve have a higher likelihood to appear in the random succession than those items for which a vote “dislike” was given and thus a low weighting factor was assigned. Preferably a dislike vote leads to weighting factor 0.5 and a like vote leads to weighting factor 2.

Another possibility to make use of the weighting factors is that the play list generator 9 generates a play list P2 for all items having a weighting factor greater than 1 and a play list P3 for all items of data having a weighting factor smaller than 1. For smart shuffle playback the random succession generator 7 takes items of play list P2 with a higher likelihood than normal items and items of play list P3 with a lower likelihood for generating the random succession. Of course also other possibilities to implement the inventive idea are possible but not all possibilities are described here.

Advantageously the device comprises a user behaviour evaluator 13, which evaluates the user behavior from information received via user interface 5. The evaluator 13 not only evaluates the specific “like” or the specific “dislike” but also other user behaviour. For example an item of content for which the user inputs a “single repeat” command after play back of said item indicates an indirect “like” of the user. Such item of data is assigned a corresponding weighting factor by evaluator 13 to be stored in weighting factor memory 12 or it is assigned to a play list P2 of play list memory 10. Similarly a selective increase of loudness for a certain item of content is indicative for an indirect “like”. The same is true for a specific jump to said item requested by the user. Actions indicative for an indirect “dislike” are skipping of a certain item, jump to the next item after several seconds of playback etc.

Memories 6, 8, 10 and 12 are shown as separate units for sake of clarity. However, some or all of them are advantageously combined into several or a single memory. This is indicated by dotted line encircling the complete memory 22. Of course, also other memory functions 23, not described here, may be part of memory 2. Similarly, some or all of the other blocks described in FIG. 1 may advantageously be provided in a single device.

FIG. 2 shows a schematic view of a device according to the invention. A playback device for compressed audio, as for example an MP3 player, is described in the following. It is connected via an output connector 3′ to an output 3 indicated here as loudspeaker. Shown is a display 14 for output of information by the user interface 5 to the user and several buttons as means for receiving input commands from the user. A play button 15 is used to toggle the device between playback mode and pause mode in case the device is already turned on. In pause mode the unit will turn off after a certain time of no input command. In case the device is turned off and the play button 15 is pressed the device is turned on. A stop button 16 is used to stop the play action if the device is playing or to turn off the device if it is already in the stop mode. A “like” button 17 is used during playback. The user activates this button 17 if he or she likes the song. This automatically puts the song into a “like” play list P2 or assigns an according weighting factor. Play list P2 will be treated similar to other play lists that the user has created in the play list memory 10. The user can review this play list P2 if desired. During shuffle mode items of content being part of the like play list P2 will have a higher chance of getting played. “Dislike” button 18 is also used during playback. The user activates this button if he or she dislikes the item currently played back. Activation of “dislike” button 18 automatically puts the item into a “dislike” play list P3. This play list, too, is treated similar to other play lists in play list memory 10 and can be reviewed via a user interface 5. The user can select to only playback items on this play list P3. During shuffle mode, items of play list P3 will have a lower chance of getting played.

A “next” button 19 initiates a skip so that the next item of content is played. This next item may be different for different play modes. However, the sequence will be preserved. That means going “next” and “previous” under the same play mode should bring up the same sequence of songs. A “previous” button 20 initiates a jump back to the previous item. Here, the same applies as for button 19.

When the device is playing an item of content, in case of an MP3 device a song, the user can activate the “like” button 17 to tag the song as “like”. This activates two things: first, this song will be grouped with all other like songs and form a system play list, the like list P2. This play list P2 can be played and viewed like other predefined play lists Pn. Second, this will increase the probability of this song getting played in a smart shuffle mode. To put it simply, all songs on the like play list P2 will be put into the bin twice during the shuffle process. Therefore, they will be played more frequently during shuffle play. Dislike is the opposite of like. Activating the dislike button 18 will put the currently playing song into another system play list the dislike play list P3. This list can also be played and viewed. Dislike also effects the probability of a song getting played during smart shuffle play mode. When it is a “dislike” song turned to be played, there is a fifty percent chance that the song will be skipped. Doing so, will decrease the probability of the songs indicated on play list P3 getting played. During play the functions of like button 17 and dislike button 18 are active. Each song can either be “like”, “dislike” or “neutral”. These functions cancel each other. For example, activating the “dislike” button 18 on a song that is already on the like play list P2 will bring it to “neutral”, i.e. removing it from play list P2. Activating the dislike button 18 again for the same song will bring it to the dislike play list P3. Shuffle button 21 initiates the shuffle playback mode.

FIG. 3 shows a flow chart of a method according to the invention. After the device is turned on it awaits a command in step S13. After a play command is given by means of the play button 15 playback is started in step S31. Playback is done in S32 according to a given succession, for example in the order of the index memory or of a play list P1. In step S33 availability of user input is checked. In case that no user input is received or a control input as change of loudness etc. is received, the input command, if available, is performed and it is continued with step S32. In case of a stop command playback is stopped in step S34 and the device returns to step S30 awaiting a command. If no command is received in step S30 for a certain time, the device automatically turns off. In case the user input command was one of the options for the like/dislike function, in step S351 it is checked whether the command refers to option 1. If it refers to option 1, the index of the item will be put to a first play list P1 in step S361 and the device returns to step S32. Otherwise in step S352 it is checked whether option 2 is selected. If it is the case the index of the item is put to play list P2 in step S362 and the system returns to step S32. Otherwise it is checked in a following step S353 similar to steps S351 and S352 above. In step S35(n−1) it is checked whether option n−1 is selected, if yes, the index of the item is put to play list P(n−1) and it is returned to step S32. Otherwise in step S36n the index is put to play list Pn and it is returned to step S32. In this example play list P1 is a user selected play list, play lists P2 to Pn are like and dislike related play lists, having a more differentiated likelihood level than the example described before. Play lists Pn+1 until Pn are play lists defined according to another rule for example additional user defined play lists. The option named here are such as generating a play list, giving a “like” or “dislike” vote etc.

In case that in step S30 a shuffle command via shuffle button 21 is received smart shuffle process starts in step S37. In step S38 a so-called bin is generated from which items are to be selected. In the simple case of only a single “like” play list P2 and a single “dislike” play list P3 all the items of play list P3 are taken once into the bin, the indices of items of play list P2 are taken four times into the bin and the remaining items are taken twice into the bin. In selection step S39 indices are randomly selected from the bin generated in step S38 to generate a new given succession to be stored in random succession memory 8. After this play as of step S31 is started using the random succession generated.

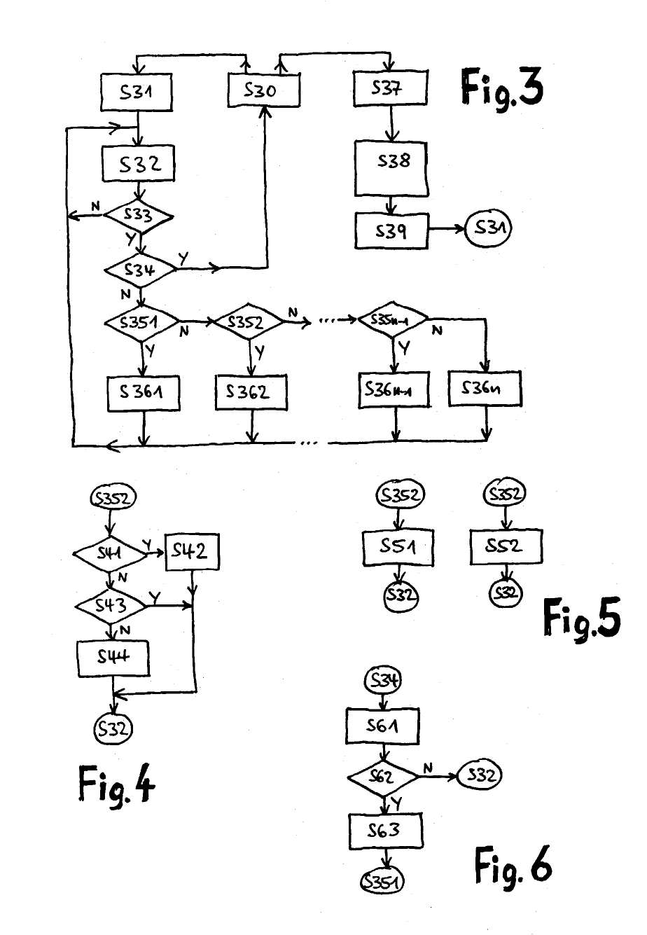

An advantageous alternative version for step S362 is described in FIG. 4. If the answer in step S352 is yes, in step S41 it is checked whether the index of the current item is on the dislike play list P3. If that is the case this index is removed in step S42 from the dislike play list P3 and it is continued with step S32. Otherwise it is checked in step S43 whether the index of the item is on the like play list P2. If yes it is continued with step S32. Else, the index of the current item is put on the like play list P2 and it is continued with step S32. Similarly step S363 and followings can be adapted for several levels of like value, and, in the opposite way for dislike values.

FIG. 5 shows another alternative version of step S362. In step S51, instead of putting an index of an item on a play list, its weighting factor is taken from weighting memory 12, multiplied by two and the result overwrites the previous value of the respective weighting factor in weighting factor memory 12. As another alternative solution, in step S52 a predefined weighting factor is taken and overwrites a previously existing weighting factor in memory 12.

FIG. 6 shows an alternative to the method as described in FIG. 3, which consists in additional steps. After the result in step S34 is “no”, in step S61 the respective command is performed. In step S62 it is checked whether the user input command already performed is indicative of any of the options. For example, a skip command given by means of the “next” button 19 may be indicative of a “dislike” option. In this case in step S63 it is continued as if a dislike command would have been received via dislike button 18 and the process continues with step S351. Similarly if the user input command is indicative of any of the other options, in step S63 a respective user input is theoretically assumed and it is continued with step S351. If the user input command is detected in step S62 as not being indicative of any option, it is continued with step S32.

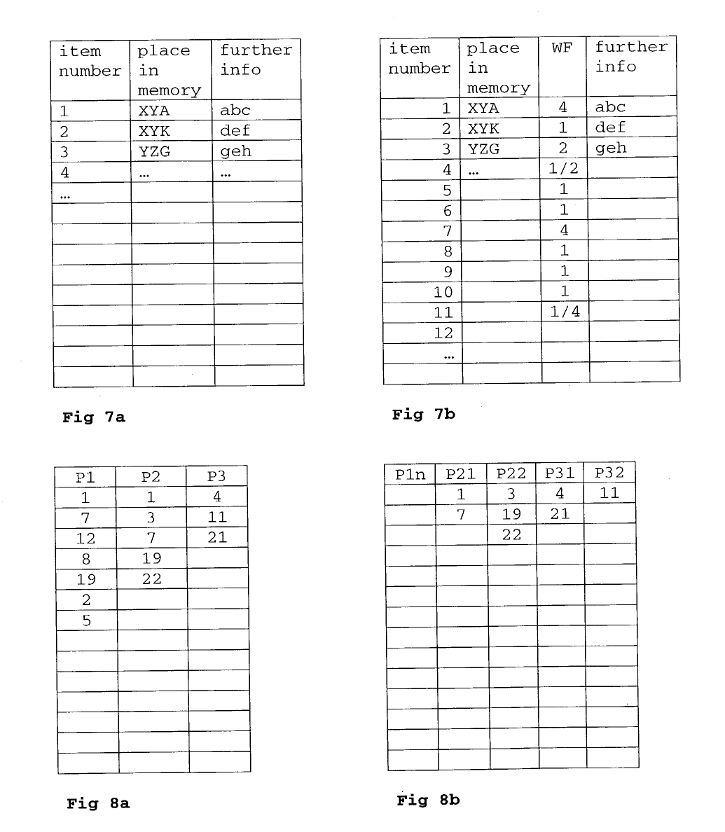

FIG. 7a shows an example of an index memory. In the first row of the table the item number is indicated as an index. In the second row the place in the content memory is indicated. In the third row further information as membership in a certain album, title of the item of content, author etc. is stored. Of course, several rows may be required to fulfill this function.

FIG. 7b shows an example of an index memory, which includes weighting factors. Previous to the last row an additional row for weighting factor is included. It can be seen that some items are assigned factor 1 indicating them as normal or “neutral”. Others having weighting factor 2 or 4 are liked or very much liked items. On the other hand, weighting factors 0.5 or 0.25 indicate dislike or very much dislike, respectively. In this case no different tables for different playing lists exist but the weighting factor indicates to which list which item belongs.

FIG. 8a shows an example of a play list memory 10. Three rows are shown. The first row contains play list P1 being a user selected play list. It can be seen that the succession is different than the one of the index memory shown in FIG. 7a and that not all items are selected. The second column shows the “liked” play list P2 containing some of the items of play list P1 but also others not yet selected by the user to be part of play list P1. Column 3 shows the “dislike” play list P3.

FIG. 8b shows a more elaborate example of a play list memory. Here, several play lists P1n being user's selected play lists are contained in the first n columns. Play list P21 is a “like much” play list, play list P22 is a “like” play list, play list P31 is a “dislike” play list and play list P32 is a “dislike much” play list. Several times pressing the dislike button 18 for the same item of content currently played back moves it to the play list P32 even if it once belonged to play list P21. The example of liked and disliked items of FIG. 8b corresponds to the example of FIG. 7b where only one column for weighting factor is provided.

In other words, the invention describes a scheme that allows the users of portable music player to show their preference to songs as they are played. It allows the Users of a Portable Music Player to enter their preference to songs that they hear while they are listening. The users can show their preference through a single “Like” or “Dislike” key press. These preferences are entered into a database. This information will then allow the Portable Music Player to treat the songs differently during shuffle play. In addition, the User can access these lists of song (Likes and Dislikes) on their PC, editing them or deleting them. The User can also delete the Dislike songs on the Portable Device.

Current Portable Music Players do not allow their users to enter their preference of the songs as the songs are played. On a Player with thousands of songs, users very often hear songs that they like, or do not like. It is very convenient that they can mark these songs very easily according to the invention. Later on, they can review the list, and save them, edit them, fix the metadata, or delete them. The invention allows the user to assess a song, and mark it “like” or “dislike”. Later on the user can review these lists on an editing device, as a PC, to save them separately, correct the ID3 tags, re-rip the songs, or to delete them. There is currently no existing device that has such “mark on the device, and review on the PC” function.

The editing device is shown in the example of FIG. 1 incorporated in the user interface 5, i.e. not as a separate apparatus. Here, the user can perform the desired functions as indicated above. For cooperation with a separate apparatus to be used as editing device, the user interface 5 is provided with necessary connectors.

List of Reference Steps for FIGS. 3-6

S30 await command

S31 play

S32 play in given succession

S33 user input ?

S34 Stop ?

S351 option 1 ?

S352 option 2 ?

S35n−1 option n−1 ?

S361 put to P1

S362 put to P2

S36n−1 put to Pn−1

S36n put to Pn

S37 smart shuffle

S38 generate bin, WF=1 for P3, WF=4 for P2, WF=2 else

S39 randomly select from bin

S41 on P3 ?

S42 remove from P3

S43 on P2 ?

S44 put on P2

S51 double WF

S52 set WF

S61 perform command

S62 command indicative of any option ?

S63 assume input of that option

What is claimed is:

1) Playback device for audio and/or video content which content (C) is stored on a content memory (1), the device having
a content reader (2) for reading content (C) from said content memory (1)
an output (3) for outputting content (C) provided by said content reader (2)
an index memory (6) for storing index data related to content (C) stored on said content memory (1)
a user interface (5) for receiving user input
a random succession generator (7) for randomly selecting a random succession (RS) of content to be played back
a playback controller (4) for controlling playback of content (C) in response to said random succession (RS)
characterized in that
the device is provided with a weighting generator (11) for generating a weighting factor (WF) for at least a part of said content (C), based on user input and in that the random succession generator (7) takes into account said weighting factors (WF).

2) Device according to claim 1, characterized in that the user interface (5) is provided with a user behaviour evaluator (13) for evaluating, from the user input behaviour, a criterion for increasing or decreasing a weighting factor (WF).

3) Device according to claim 2, characterized in that it is provided with a play list generator (9) for generating a play list (P2, P3) based on weighting factor (WF).

4) Device according to claim 1, characterized in that it is provided with a play list generator (9) for generating a play list (P2, P3) based on weighting factor (WF).

5) Device according to claim 1, characterized in that the user interface (5) is provided with a first input (17) for increasing a weighting factor (WF) and a second input (18) for decreasing a weighting factor (WF).

6) Device according to claim 5, characterized in that the user interface (5) is provided with a user behaviour evaluator (13) for evaluating, from the user input behaviour, a criterion for increasing or decreasing a weighting factor (WF).

7) Device according to claim 6, characterized in that it is provided with a play list generator (9) for generating a play list (P2, P3) based on weighting factor (WF).

8) Device according to claim 5, characterized in that it is provided with a play list generator (9) for generating a play list (P2, P3) based on weighting factor (WF).

9) Method for automatically generating a succession of content (RS) to be played back from a content memory (1) having the steps of
collecting (S32, . . . , S36n) information by
playing back (S32) items of content in a given succession
receiving (S33) user input during said playback
generating (S351, S361, . . . , S36n) a play list based on said user input
assigning (S38) weighting factors to the items on said play list (P2, P3), which weighting factors (WF) are different from those of the other items of content
upon request (S37) to automatically generate a succession, randomly selecting (S39) the next item to be played back from all items available, wherein the probability for each item to be selected corresponds to its weighting factor (WF).

10) Method according to claim 9, wherein said user input is selected from at least two different options, said options causing different weighting factor (WF) assignment.

11) Method according to claim 10, wherein the step (S351, S361, . . . , S361n) of generating a play list comprises generation of at least two different play lists (P2, P3, P21, P22, P31, P32) in response to different user input options.

12) Method according to claim 10, characterized by the further step (S41, . . . , S44) of evaluating (S41, S43) user input to derive a criterion for assigning (S42, S44) an item of content to a certain play list (P2, P3).

13) Method according to claim 9, wherein the step (S38, S51, S52) of assigning a weighting factor (WF) comprises one of
taking (S52) a predefined weighting factor value and replacing an existing weighting factor value by said predefined weighting factor value, and
changing (S51) an existing weighting factor (WF).

14) Method according to claim 9, wherein the step (S351, S361, . . . , S361n) of generating a play list comprises generation of at least two different play lists (P2, P3, P21, P22, P31, P32) in response to different user input options.

15) Method according to claim 9, characterized by the further step (S41, . . . , S44) of evaluating (S41, S43) user input to derive a criterion for assigning (S42, S44) an item of content to a certain play list (P2, P3).

16) Method according to claim 9, wherein several play lists are combined in a single table, each item of the table having a weighting factor (WF) assigned thereto, said weighting factor (WF) being one criterion to define the items belonging to a certain play list.

17) Method for editing an automatically generated succession of content having the steps of
generating a succession of content according to claim 9
transferring said succession to an editing device
edit said succession by means of the editing device
transferring back said edited succession.
